(19) United States
(12) Patent Application Publication
(10) Pub. No.: US 2003/0151580 A1
(43) Pub. Date: Aug. 14, 2003

(54) Motion video cholesteric displays

(76) Inventor: Yao-Dong Ma, San Jose, CA (US)

Correspondence Address: Yao-Dong Ma, 1866 Bethany Ave., San Jose, CA, 95132, US

(21) Appl. No.: 10/073,529

(22) Filed: Feb. 11, 2002

(51) Int. Cl. G09G 3/36

(52) U.S. Cl. 345/96

(57) ABSTRACT

The present invention relates to cholesteric liquid crystal display, especially, to a passive motion video cholesteric liquid crystal display. The display provides not only a video speed with full color moving picture when supplying electric field, but also a video-rate response, long-term memory and high-resolution image in the absence of electric field. The field-induced nematic texture has been denoted as an optical state and cholesteric focal conic texture as another optical state during the video rate display mode. And the cholesteric planar texture has been denoted as an optical state and cholesteric focal conic texture as another during the storage-type display mode. The video rate addressing is accomplished by a narrow pulse scanning at a seed of 30-60 microseconds per row. The novel display mode and driving means deliver a passive display with a property that the display not only looks like a TV or a computer monitor dynamically but also like a permanent picture or prints statically.

### BACKGROUND OF THE INVENTION

Cholesteric liquid crystal displays are characterized by the fact that the pictures stay on the display even if the driving voltage is disconnected. The bistability and multistability also ensure a completely flicker-free static display and have the possibility of infinite multiplexing to create giant displays and/or ultra-high resolution displays. In cholesteric liquid crystals, the molecules are oriented in helices with a periodicity characteristic of material. In the planar texture, the axis of this helix is perpendicular to the display plane. Light with a wavelength matching the pitch of the helix is reflected and the display appears bright. If an AC-voltage is applied, the structure of the liquid crystals changes from planar to focal conic texture. The focal-conic texture is predominately characterized by its highly diffused light scattering appearance caused by a distribution of small, birefringence domains, at the boundary between those domains the refractive index is abruptly changed. This texture has no single optic axis. The focal-conic texture is typically milky-white (ie., white light scattering). Both planar texture and focal-conic texture can coexist in the same panel or entity. This is a very important property for display applications, whereby the gray scale can be realized.

However, current cholesteric displays are limited in low frame speed, storage type devices. Since very beginning, one has dreamed to achieve a good moving picture by using variety of methodologies, but it seems to conclude that cholesteric display with passive driving is almost impossible to realize a true video rate display which is over 30 frames per second.

In the article of “Storage-Type Liquid Crystal Matrix Display” (SID 79 Digest, p. 114-115) Tani proposes a driving method for the ChLCD. The display adopts a vertical alignment treatment and the liquid crystal pixel can be driven from stable planar texture to stable focal conic texture or from stable focal-conic texture to stable planar texture depending on the pre-designed waveform. The hysteresis behavior during the phase transition of nematic-cholesteric liquid crystal under an applied electric field can be used for bistable display for high multiplex application. The stability of the hysteresis effect was defined as the width of hysteresis. That is the difference between the voltage, which gives 50% transmittance in cholesteric-to-nematic phase transition and the voltage, which gives 90% in nematic-to-choloesteric phase transition. This behavior has been used for projection display where a large information content is required.

It is well known that only dielectrically positive cholesteric LC cells with homeotropic boundary conditions have an electro-optical hysteresis effect. The LC cell in its quiescent state assumes an almost transparent spiral texture. It alters to scattering fan-shaped texture upon voltage application, and transforms at threshold voltage to a homeotropic nematic texture as a result of the field-induced phase transition. The cell remains in a metastable homeotropic texture for a rather long time, when the voltage is lowered from V₁ (V₁>V_{H}) to V₂ (V_{H}>V₂>V_{H}′≅V_{H}/2). When the applied voltage is switched off from V₁ (or V₂) to zero, a rapid relaxation from the transparent nematic texture H (or H′) to the initial quiescent texture. Light transmission during the rapid passage exhibits a hump G* before it reaches minimum at state G′. The state G* was found to be a transient planar texture, and the time interval of the transition from texture H (or H′) to texture G* is interpreted to be the nematic-chloesteric transition time, τ_{NC}. If voltage V₂ is applied after a time interval, such that t₀>τ_{NC}, a scattering texture F′ is formed, which transforms to stored scattering texture F₀ after the voltage removal. Thus, scattering texture F₀ and transparent texture S can be selected by either putting t₀>τ_{NC} or t₀=0. This is the basic principle of this storage-type LCD. In the case of a matrix display, the number of scanning lines is limited by the ratio T/t₀. T and τ_{NC} values are usually several seconds and several milliseconds, respectively. Therefore, the ratio T/t₀ can be as high as several hundred.

The matrix display panel described is driven by a line-at-a-time addressing. The addressing process is proceeded by the pre-excitation process that the higher voltages V₁ larger than V_{H} are applied to all matrix elements. This pre-excitation process corresponds to the initial stage where the liquid crystal is made homeotropic. In the matrix display, scanning signals are applied to the row electrodes and data signals are applied to the column electrodes. V₍₀₎ and V_{(π)} are ac pulses, which have the same height and 180° phase difference. The pulse heights of V₍₀₎ and V_{(π)} are less than V_{H}. The voltage of scanning signals is 0 for non-addressed lines, and V_{(π)} for an addressed line. The voltage of data signals is V₍₀₎ for non-addressed lines, and V_{(π)} for an addressed line. Therefore, the voltage applied to the addressed element is 0, and V or 2V is applied to the other elements. After this addressing process, the voltage for all elements are removed.

Through a total writing process, the applied voltage changes in ways as V₁ →V→0→V→0 or V₁→0→V→0 at the addressed element, which makes the liquid crystal the stored light scattering state. On the other hand, the voltage change at the on-addressed element is V₁→V→2V→V→0 or V₁→2V→V→0, which makes the LC the quiescent transparent state. The existence of the 2V pulse has on influence on the metastable homeotropic state H′ since 2V is larger than V_{H}. In this way, the matrix panel forms the stored image. The V₂ range giving successful display performance is given by the inequality 0.6<V/V_{H}<0.9, which gives a variation allowance in LC layer thickness d.

The storage type display has the advantages of long storage time, which makes refreshing or updating of the information on the display unnecessary. However the scanning speed is relatively slow and each line needs 8 ms to address the pixels and the information can not display till the whole frame scanning is accomplished. The power consumption is high because of the two phase change voltages to the non-selection pixel and multi driving pulse sequence are over the phase change (untwist threshold) voltage.

U.S. Pat. No. 5,748,277 divides the information writing into three stages, i.e. preparation, selection and evolution. In the first preparation phase, a pulse or series of pulses causes the liquid crystal within the picture element to align in homeotropic texture and the display looks dark. The second stage is named selection step, during which the voltage added to the liquid crystal within the picture element are chosen so that the final optical state of the pixel will be either focal conic or twisted planar. In practice the voltage is chosen to either maintain the homeotropic texture or reduced enough to initiate a transition to the transient twisted planar texture. The third stage is evolution step, during which the liquid crystal selected to transform into the transient twisted planar texture during the selection step now evolves in a focal conic texture and the liquid crystal selected to remain in the homeotropic texture during the selection phase continues in the homeotropic texture. After evolution stage, there comes actually display stage where the voltage is taken to near zero or removed entirely from the pixel. The liquid crystal domains that are in the focal conic texture remain in the focal conic texture and those in the homeotropic texture transform into a stable light reflecting planar texture. The reported addressing time was reduced to 1 ms/line.

In the article of “High-Speed Dynamic Drive Scheme for Bistable Reflective Cholesteric Displays” (SID 97 Digest, p.97-100) Zhu proposes a five-phase driving method for the ChLCD, which is composed of five phases: preparation, post-preparation, selection, post-selection, and evolution. The state of the material after addressing depends only on the voltage in the selection phase that is around 50 μs long. The voltages in other phases are fixed at appropriate value and the drive waveform is implemented using a pipline algorithm. Using this drive scheme, it is able to update a 1000 line cholesteric display in approximately 0.05 seconds. However, video rate display is still impracticable. The fundamental problem is that the relaxation from the transient planar texture to the intrinsic stable planar texture will take about 200 ms, too long for a video rate display. Although it can be driven a frame as fast as 50 ms, the display does not relax completely to the planar texture during this time, and consequently the display had a very low brightness.

U.S. Pat. No. 5,661,533 teaches a method to speed up the relaxation time from field-induced-nematic texture to planar texture by dope a surfactant to liquid crystal material. It was realized that the response time has been reduced from 150 ms to 150 μs. The problem with the system was that the surfactant has high conductivity and the liquid crystal formula is not stable and reproducible. The video speed display with good performances has not been reported since the invention of the surfactant-liquid crystal system.

### SUMMARY OF THE INVENTION

It is the primary object of this invention to realize a motion video cholesteric display with frame rate at least 30 frame per second.

It is another object of this invention to eliminate the slow relaxation process, i.e., from field-induced nematic texture to cholesteric planar texture instead, the field-induced nematic texture is devised as one of the optical state during the motion video display, whereby the field-induced nematic texture or homeotropic texture takes on a high transparency in optical “ON” state.

It is a further object of this invention to utilize the fast relaxation-process, i.e., from field-induced nematic texture to cholesteric focal conic texture via transient planar texture. What is different from the prior art is that the motion video display takes the advantage of the fast-response focal conic texture, as the optical “OFF” state.

It is again another object of this invention to devise a driving scheme for a passive multiplexed motion video display. The driving scheme creates a special waveform to ensure a field-maintaining bitability during the motion video display, and a field-free bistability during the motionless information display. A narrow pulse planted in the “hole” shaped waveform will be able to drive the display to the optical “ON” state, while the “hole” shaped waveform itself driving the display to the optical “OFF” state. After erasing at least one portion of a frame, there comes an incremental line-to-line addressing waveform at the speed of 30-60 microsecond per line.

It is a still further object of this invention to create a display structure that takes the best advantage of the cholesteric intrinsic polarization and depolarization properties, thus produces black-and-white display and, furthermore, full color display. Compared with the traditional cholesteric display where the planar and focal conic textures are designated as the optical “ON” and “OFF” states, those skills of the art deliver even higher display performances, such as multi-gray scale, high brightness, high contrast ratio and wide viewing angle.

It is additional object of this invention to render the display dual working functions. During the motion video display, the frame response is achieved by a video rate driving scheme. During the motionless information display, the display device will automatically convert to its field-free bistable mode, and further remain its long-time memory with zero power consumption. In one word, the present invention delivers a display with a property that it makes the display not only a TV or a computer monitor dynamically, but also a permanent picture or a print statically.

### BRIEF DESCRIPTION OF THE DRAWINGS

FIG. 1 illustrates schematic sectional display structures and configuration working in the motion video mode and motionless storage mode.

FIG. 2 illustrates an electro-optical curve of a cholesteric liquid crystal display.

FIG. 3 illustrates a schematic optic “OFF” waveform and focal conic relaxation of the first display scanning line.

FIG. 4 illustrates a schematic optic “ON” waveform and optical response of the first scanning line.

FIG. 5 illustrates a schematic optic “OFF” waveform and focal conic relaxation of the “m” scanning line; and also an optic “ON” waveform and optical response of the “m” scanning line.

FIG. 6 illustrates a schematic inter-frame waveform and optical response.

FIG. 7 illustrates a schematic erasing and addressing driving waveform for the video rate cholesteric display.

FIG. 8 illustrates a schematic driving waveform with partial erasing and addressing capability and gray-scale display capability.

### DETAILED DESCRIPTION

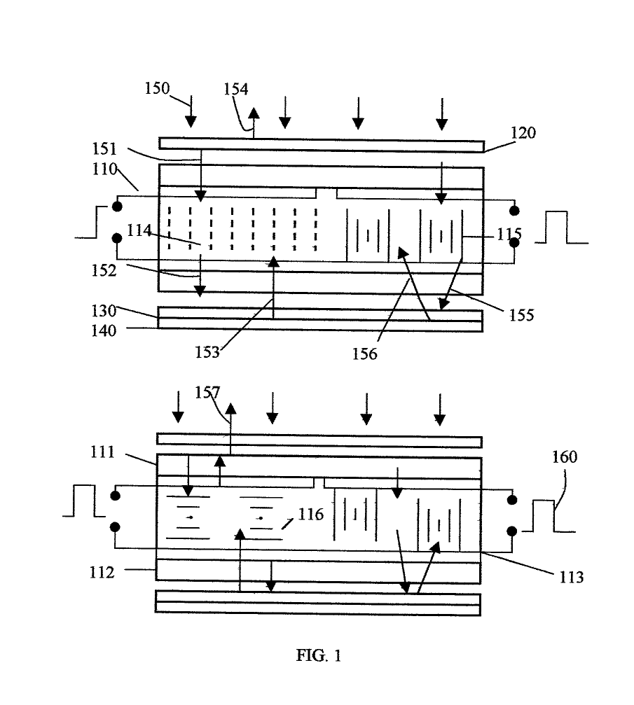

Referring first to FIG. 1, illustrated is a reflective black-and-white cholesteric display structure. It consists of a display cell 110, two circular polarizers (CPs) 120, 130, and a metal reflector 140. The cell 110 is a basic structure of liquid crystal display, where a liquid crystal material with controllable homeotropic texture 114, controllable focal conic texture 115 and controllable planar texture 116 are sandwiched between two patterned conductive substrates 111, 112 (either glass or plastic) and isolated by a polymeric ring. The cell gap, which is predetermined by a spacer material, micro-balls or bars, is in the range of 1 to 10 micrometers. A thin polymer layer may be coated onto the inside of surfaces of the substrates to align the liquid crystal molecules in a specific way. An electronic waveform 160 needs to connect to the conductive lead 113 of the cell. In the case of multicolor or full color display the concept of cell will be changed. Each color cell called sub-pixel and one-pixel consists of three sub-pixels.

The natural light 150 first reaches the first circular polarizer 120 with the same handedness as liquid crystal, for example right handed circular polarizer (RHCP) for the convenience of description. 50% left handed (LH) of incoming light is filtrated by the RHCP and other 50% right handed (RH) 151 is allowed to pass. The RH component then reaches the ChLC film in the field-induced nematic texture 114 and then passes through the ChLC film without substantially change its polarization status. The component further passes the second RHCP 130 (see light 152) without attenuation and is reflected by an Aluminum reflector 140, with the function of changing the light direction while maintaining the sense of polarized light. Furthermore the light 153 passes all the way through the second RHCP, ChLC film and the first RHCP without optical loss and finally emerges to the display front surface 154. In this way, a viewer can see a full spectrum visible light.

The first and second CPs 120, 130 are made of linear polarizers and ¼ λ retardation films with 45° superimposed together. In the case of infrared ChLC formulation, the ChLCD is tuned in invisible wave band. It is highly recommended to use linear polarizers instead of the circular polarizers if only the angle between the main molecular axis and the optical axis of the linear polarizer meets the light guiding requirements. The optical “ON” state in field-induced nematic texture is an untwisted homeotropic texture regardless whether the ChLC is tuned in visible wavelength or invisible wavelength. The usage of CP herein is for dual-purpose applications: video rate display and storage type static display.

When the display is chosen a storage mode after a video speed display mode, the electric field will be withdrawn rapidly from the ChLC film in homeotropic texture and the ChLC relax into a planar texture 116. The display becomes bistable full spectrum reflective display introduced in U.S. patent application Ser. No. 09/393,947, herein incorporated by reference. The out-coming light 157 then is composed of two reflections: Bragg reflection and metal reflection.

For video rate display applications the linear polarizer is totally qualified for such optical “ON” state, no matter the ChLC is tuned in visible or invisible wavelength.

As the ChLC domains addressed in a focal conic texture 115, the display works at optical “OFF” state. The incident light 150 reaches the first CP 120 with the same handedness as the ChLC and is cut more than 50%. The rest 151 will get to the ChLC cell with focal conic texture and be depolarized by the scattering effect of the LC material. The neutral non-polarized light 155 then passing linear polarizer becomes linear polarized at the cost of at least 50% light being cut off. The linear polarized light is then reflected by the aluminum thin layer 140 and further is circularly polarized by the second CP 130 located between the ChLC cell and the metal reflector. The remaining light 156 passes the ChLC cell again and becomes depolarized light due to the focal conic scattering effect. The non-polarized remaining light reaches the first CP and half of it is lost. Finally, only small portion of total light less than 4% can reach to the front as scattered polarized light. The scattering emerged light has large viewing cone so that human eye perceives only a small portion of it. Thus the display in optical “OFF” state takes on black appearance.

The key to the motion video display is that the homeotropic metastable texture has been used for one of the optic state and the focal conic stable texture has been used for the other optic state. Both the homeotropic and the focal conic textures have fast addressing speed compared with the planar texture. The fundamental problem with the planar texture is that the relaxation from the transient planar texture to the intrinsic stable planar texture will take about 200 microsecond. The present invention takes full advantage of cholesteric liquid crystal material: field maintained homeotropic texture as a video rate display mode and field-free planar texture as a static display mode. Both the homeotropic texture and planar texture have similar appearance to the viewer.

The black-and-white display introduces a novel way to realize real video display with relative higher contrast ratio and brightness. Prior art cholesteric display does not look bright because of most of the incoming light being absorbed by the black back coating material. By utilizing the full spectrum of incoming light, the total brightness of the display is enhanced in the video rate driving speed. One may notice the fact that the homeotropic video speed display has even better contrast ratio than that of the planar static display mode due to the higher transmittance of the homeotropic texture than that of the planar texture.

The motion video display of this invention is not limited only in the reflective display. It can also be suitable in the transmissive display or transflective display. In transmissive displays, the field-induced nematic or homeotropic area will take on dark optic “OFF” state during the video rate operation and remain the dark state after the video rate operation. While the focal conic texture area will take on bright optical “ON” state due to the back-lit illumination. Either reflective or transmissive mode display requires that the homeotropic metastable state and the planar stable state have the same optical appearance, while the other stable state, focal conic texture has a different optical appearance.

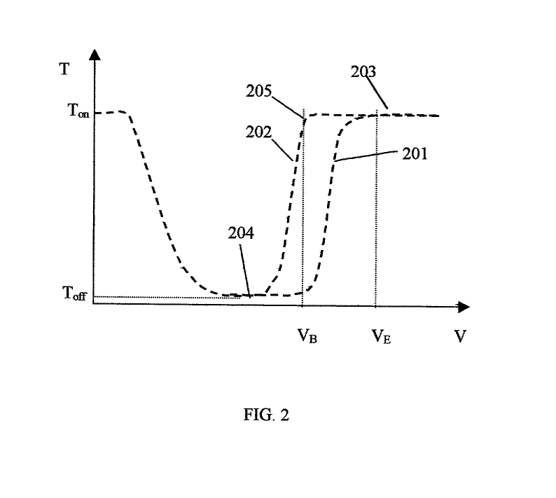

Turning now to FIG. 2, illustrated is an electro-optical curve of a ChLCD. The ramp-up section of the curve 201 represents an optical transition from the focal conic texture to the field-induced nematic texture. The decay section 202, meanwhile, represents another optical transition from the field-induced nematic or homeotropic texture to the focal conic texture. High level in transimittance section 203 represents the field-induced nematic texture. Note that the section 203 is not equivalent to the reflection of the planar texture depicted in the prior art because there is no relaxation process from homeotropic texture to the planar texture during the video speed display. The bottom section of the curve 204, finally, represents the focal conic texture of the display. The low transmittance of the focal conic texture is not due to the black-printing layer on the back of the display panel, instead, is due to the depolarization effect of ChLC in focal conic texture and the multi-path absorption of the polarizers which create the optic “OFF” state.

Most importantly, this invention takes advantage of the electric controllable hesteresis, a metastability effect of the cholesteric liquid crystals. The hesteresis appears that the decay section 202 keeps parallel with the ramp-up section 201 before merge together at the two ends, a hesteretic loop. Unlike other cholesteric textures, such as planar and focal conic textures, where exist intrinsic field-free memory; the homeotropic texture has a field-maintained memory for its hesteretic loop. Generally speaking, the characteristics of the nematic to cholesteric phase relaxation constitute the metastability. As the applied voltage is decreased after the ChLC reaches its field-induced nematic phase, the relaxation may have one of the following behaviors: nonhysteretic, hysteretic, tristable, or persistent. Amount those, hysteretic, tristable and persistent are usually called the metastability of cholesteric materials. Theoretically, there is an energy barrier against the nucleation of the focal conic domains when the ChLC transforms from the homeotropic texture to the focal conic texture. It is the energy barrier that generates the hesteresis.

It was reported that the ratio of the cell thickness to the helical pitch of ChLCD, D/p, is a key factor of the hesteresis and other matastability effect (Caterin G. Lin-Hendel. Appl. Phys. Lett. 38,8, 1981). The hesteresis exists when the ratio, D/p>2.5.

It was also reported by researchers in Kent State University that the polymer stabilized cholesteric texture would enhance the hesteresis loop ( D.-K. YANG. Polymer-stabilized Cholesteric Textures, Materials and Applications, P 129).

The applicant discovers that liquid crystal material and driving method are also important to produce a suitable hesteresis. It is realized that at the same cell gap and the same reflective wavelength, some liquid crystal formulations have hesteresis and some of them do not have hesteresis, despite the fact that the ratio of the cell gap to the helical pitch meets the rule of D/p>2.5. Such exception of not following the rule of D/p ratio is, now, under investigation. It is also realized that electric driving condition could fine-tune the hesteresis to the optimal level that is most suitable for the video rate display. Intensive study has shown that the width of hesteresis can be precisely controlled by electric signal applied onto the same ChLCD cell. More detailed description regarding the electric modulation of the hesteresis will be disclosed separately.

There are two voltage levels physically applied onto the video rate display pixels: V_{E} and V_{B}. V_{E} is the erasing pulse, which drives all the pixels into homeotropic texture. V_{B} is the maintaining bias pulse with the amplitude, 0.1V_{CN}≦V_{B}≦0.9 V_{NC}, which keeps all the pixels either in the metastable “Tₒₙ”, homeotropic texture or stable “T_{off}”, focal conic texture (strictly, excited stable focal conic texture). However, from the FIG. 2, one cannot find a decisive voltage level that determines the optical states of the display.

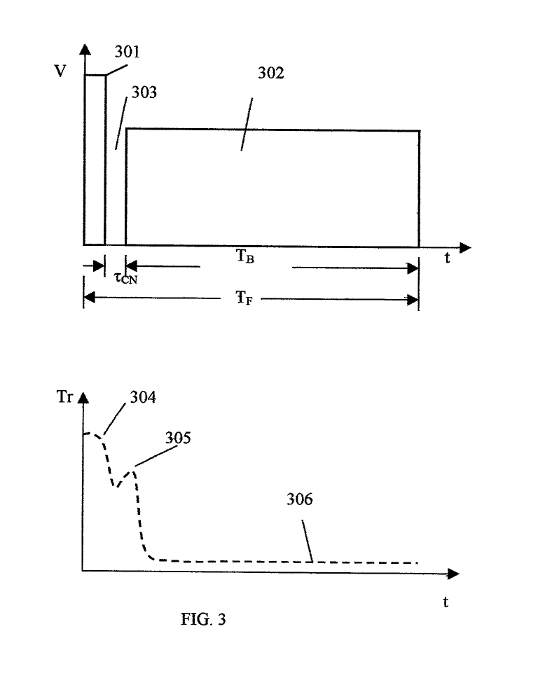

Turning now to FIG. 3, illustrated is a waveform driving ChLC cell into focal conic optic “OFF” state. The LC cell in its quiescent state is supposed to be an almost transparent texture 304. It alters to scattering focal conic texture upon erasing voltage, V_{E} ,application, and transforms at threshold voltage to a homeotropic nematic texture as a result of the field-induced phase transition. When the applied voltage is switched off from V_{E} to zero, a rapid relaxation will take place from the transparent nematic texture H to the initial quiescent texture. Light transmission during the rapid passage exhibits a hump 305 before it reaches minimum. The state 305 was found to be a transient planar texture, and the time interval of the transition from texture 304 to texture 305 is interpreted to be the nematic-cholesteric transition time, τ_{NC}, which is approximately within the range of 1 ms. If voltage V_{B} is applied after a time interval, such that t₀>τ_{NC}, an excited focal conic texture is formed, which transforms to stable focal conic texture after the voltage V_{B} removal. What is different from the prior art bistable storage type ChLCD is that the short pulse V_{E} is an erasing pulse that exerts all the display pixels in a frame at the same time, and the V_{E} is the only one pulse during the frame information addressing. Another fundamental difference from the prior art is that the “hole” 303 scans all over the display in a way of line-to-line rolling, starting from the first row to the final row of a display frame. Each row has only one “hole” within a frame while the rest rows are always keeping the same voltage level, V_{B}. Furthermore, each hole represents an optic “OFF” state.

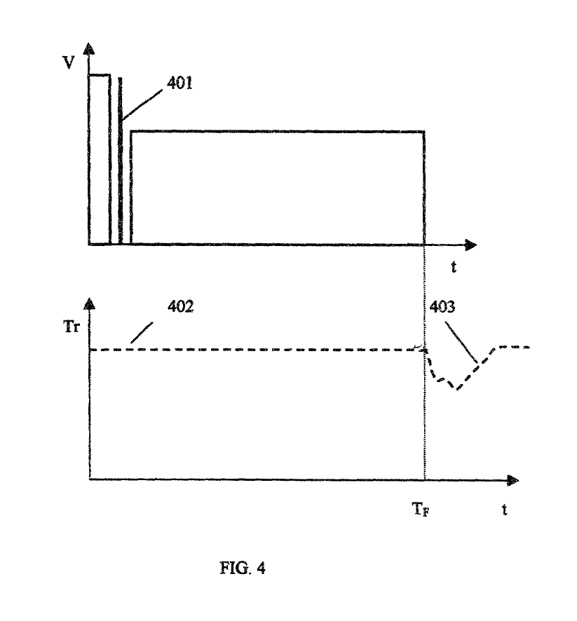

Turning now to FIG. 4, illustrated is a waveform driving ChLC cell into field-induced nematic or homeotropic optic “ON” state The LC cell in its quiescent state is assumed to be an almost transparent texture. It alters to homeotropic texture upon the application of the erasing voltage, V_{E}. When the applied voltage is switched off from V_{E} to zero, a rapid relaxation from the transparent nematic texture to the cholesteric transient planar texture tends to occur without any extra energy. The present invention devises a narrow pulse 401 inserts the “hole”, which breaks out the further transition from homeotropic to the cholesteric relaxation, instead, energizes the liquid crystal molecules back to the homeotropic texture. As a result, the liquid crystal molecules will remain its homeotropic texture 402 all the way to the end of the frame. The pulse width of 401 is in the range of 10 to 100 microseconds, more preferably, 20 to 60 microseconds. The height and position is also critical to the video speed driving scheme. Another fundamental difference from the prior art is that the narrow pulse scans all over the display in a way of line-to-line rolling, starting from the first row to the final row of a display frame. Each row has only one narrow pulse within a frame while the rest rows are always keeping the same voltage level, V_{B}. Furthermore, each narrow pulse represents an optic “ON” state. By the end of the frame addressing, if the voltage V_{B} is withdrawn rapidly, the ChLCD will relax to the stable planar texture via the transient planar relaxation curve 403. Such relaxation time normally is in the range of 20 milliseconds to 20 seconds depending on variety of parameters. Obviously, such relaxation should be avoided in the fast video rate display, but it is useful in a static display for its zero-field permanent memory effect. Compared with the section of 402 and 403, one may find out that both the motion video display and the motionless storage display have almost the same optical bright appearance.

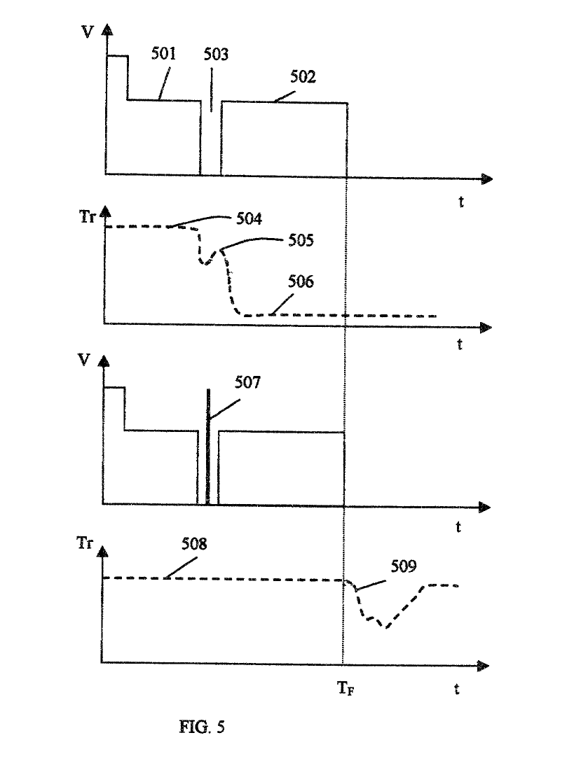

Turning now to the FIG. 5, illustrated is a waveform and its optical response curve of “m” line addressing. The first line's addressing has already depicted in FIG. 3 and FIG. 4 separately. Assuming that a line-at-a-time addressing from the first line to the “m−1” line has already passed when the scanning address comes to the “m” line. The waveform section 501 at voltage level, V_{B}, ensures the liquid crystal molecules in the homeotropic texture 504 after the erasing pulse V_{E}. And the waveform section 502 ensures to maintain the optical states 506, 508 having been addressed in the “m” line. The “hole” 503 positioned at “m” line activates all the programmed pixels in the line relaxing to focal conic texture through a transient planar texture 505. In other words, the “hole” at the line drives all the related pixels to the optic “OFF” state. At the same time, a narrow pulse 507 planted in the “hole” 503 will bridge all the programmed pixels in the line, maintaining their homeotropic texture 508. In other words, the narrow pulse at the line drives all the related pixels to the optic “ON” state.

By the end of the frame addressing, if the voltage V_{B} is withdrawn rapidly, the ChLCD pixels, pre-set in the focal conic texture, will maintain its optical “OFF” state. And the pixels, pre-set in the homeotropic texture, will relax to the stable planar texture via the transient planar relaxation curve 509. Such relaxation time normally is in the range of 20 milliseconds to 20 seconds depending on variety of parameters. Obviously, such relaxation should be avoided in the fast video rate display but it is useful in a static display for its zero-field permanent memory effect.

More logically, the “hole” 503 is termed Data “0” signal; and the narrow pulse 507 is termed Data “1” signal.

Data “1” signal can be further modulated to achieve a mixture of homeotropic texture 508 and focal conic texture 506 within one pixel so as to obtain a gray-scale in the video rate display environment. Herein the modulation means that the pulse height can be modulated according to the data signal.

The key to the waveform of the motion video display is that after the whole frame erasing pulse, there is only one hole per line per frame, which is the time window of recording. However, each row's addressing time is not determined by the width of the “hole”. Instead, it is determined by the width of the narrow pulse, in other words, the width of Data “1” signal.

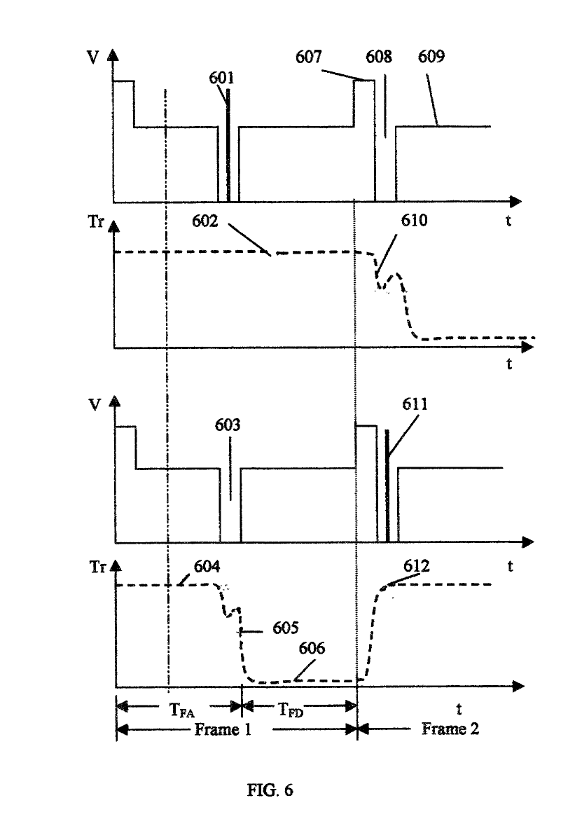

Turning now to the FIG. 6, illustrated is a waveform and its optical response curve of inter-frame addressing. During the course of the last line's addressing in previous frame, Data “1” pulse 601 maintains the pixel in the optic “ON” state and Data “0” 603 activates the pixels from homeotropic texture 604 to the focal conic optic “OFF” state 606 via the transient planar texture 605. A minimum display time T_{FD} is necessary to ensure display's contrast ratio in the last portion of the display panel. Thus an optimal duration of focal conic optic “OFF” state 606 is essential to the driving means. After a consecutive line-to-line addressing in the previous frame, an erasing pulse of a new fame 607 is applied onto all the pixels of the display panel. It erases all the information addressed in the previous frame, no matter whether the previous optic state is focal conic texture 606 or homeotropic texture 602. Before the failing edge of the erasing pulse, all the pixels will be energized to field-induced nematic phase or homeotropic texture. The basic function of 607 is the same as the first erasing pulse 301. However, The erasing pulse width of the new frame is much shorter than the first erasing pulse 301. For example, the new erasing pulse can be devised in the range of 1-5 milliseconds. Thus, a viewer in the continuous video rate display will not discern such a short erasing period.

The short erasing pulse attributes to the following reasons. First, the previous data in the optic “on” state have already been set in the homeotropic texture, only a little more energy is necessary to increase the order parameter of the field-induced nematic configuration. Secondly, the previous data in the optic “off” state are, as a matter of fact, an excited focal conic texture due to the constant activation V_{B}. In such excited focal conic texture, the fan-shaped domains vibrate relatively with each other resulting in a stronger scattering to the incoming light and higher depolarization efficiency than that of the quiescent focal conic texture. Therefore, a short erasing pulse will be enough to drive the excited focal conic texture to the field-induced nematic texture.

The functions of the “hole” 608 or Data “0” and narrow pulse 611 or Data “1” are similar to 603 and 601 in terms of addressing the ChLCD to the focal conic texture 610 and homeotropic texture 612 respectively.

One may notice that during the continuous inter-frame addressing, there is no any relaxation from field-induced nematic to the planar texture happened, so that a motion video display can be achieved.

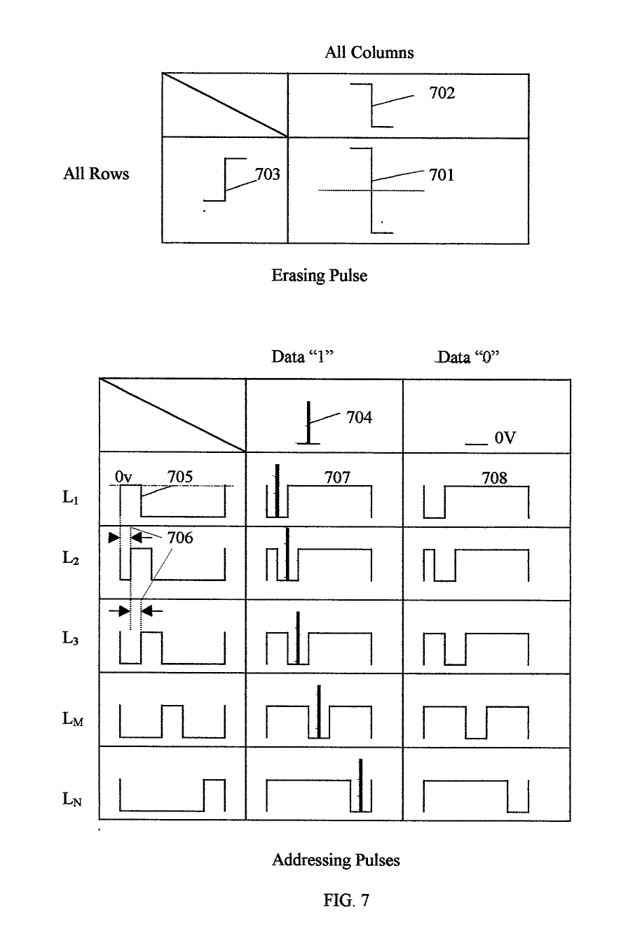

Turning now to the FIG. 7, illustrated is a video speed driving scheme. The erasing pulse 701 synthesized by out-phase waveform 702 and 703 from column and row driver is applied all the pixels at the beginning of the frame addressing. Column driver also generates a-positive Data “1” pulse 704 with narrow pulse-width and high signal frequency. Row driver, at the same time, generates a negative pulse 705 that shifted from the first row to the last row of the frame, subsequent to the frame erasing pulse. The interval between the two negative pulses 706 is equal to the Data “1” pulse-width Δτ. The Data “1” waveform 707, and the Data “0” waveform 708, synthesized by the column driver and the row driver, are applied onto the display pixels from L₁ to L_{N} consequently. The Data “1” narrow-pulse and Data “0” hole, as a-part of the waveform, are also shifted from one line to another with an interval of the Data “1” pulse-width. The frame addressing time is:

T_{FA}=T_{E}+τ_{NC}+nΔτ

Assuming the erasing pulse, T_{E}=2 ms, Scanning pulse, τ_{NC}=1 ms, Data “1” pulse-width, Δτ=0.03 ms and the row number, n=500, then

T_{FA}=2+1+15=18 ms.

Assuming, again, the display time per frame,

T_{FD}=15 ms,

Then the total frame time is

T_{F}=T_{FA}+T_{FD}=33 ms.

There will be 30 frames information displayed per second. Thus achieves a normal VGA type video rate display.

One may notice that the display time, T_{FD}, prolongs the frame time. Furthermore, it directly impacts the feasibility of video speed display with very high resolution. To achieve a video rate large panel display, for instance, SVGA (800×600), XGA (1024×768) etc., the display time, T_{FD}, should be further reduced or even eliminated. Dual-scan, with two column drivers attached each side of the column electrode respectively and the electrode, along the column direction, broken into half-and-half at the center of the display, is a good solution. An original frame, now, is divided into two sub-frames. The two sub-frames are capable of working alternatively. For example, one sub-frame that has just finished addressing will subject to the display mode, while the other one is carrying out erasing and addressing-process. As far as the whole display panel is concerned, there is always constantly scanning. Therefore, the frame time will be

T_{F}=T_{FA}=T_{E}+τ_{NC}+nΔτ

Take a 1024×768 display for example, assuming the erasing pulse T_{E}=2 ms, Scanning pulse τ_{NC}=1 ms, Data “1” pulse-width Δτ=0.04 ms and the row number n=768, then

T_{F}=2+1+30.7=33.7 ms.

There will be 30 frames information displayed per second on a 1024×768 LCD-panel.

Though the erasing high pulse is an AC waveform, the addressing pulse belongs to DC waveform within one frame. To obtain a DC-free driving voltage on each pixel, the polarity of the addressing pulse needs to be switched over every individual frame. A frame high/low signal from the LCD controller enables those functions. By so doing, there will be no DC charge accumulated in the video rate display.

The above-mentioned driving means possesses the following advantages:

1. Simplicity of waveform

The erasing and addressing pulses have relatively simple waveform and less voltage levels. There are four voltage levels altogether in the display drive scheme, which allows utilizing the commercially available “polar” CMOS driver, for example, STN driver.

2. DC-free erasing pulse

Since the erasing pulse is a high voltage pulse, any possible DC component will cause a huge negative impact on the display's working condition and display's longevity. The designed erasing pulse is synthesized by out-phase waveforms from column and row driver, so that there is no any DC component at any time.

3. Simplicity in driving logic design

Data signal in the present invention becomes a standard binary system: Column signal Data “1” is a narrow pulse and column signal Data “0” is actually a zero pulse. Scanning row signal, on the other hand, becomes a negative pulse shifting from the first line to the last line of a frame.

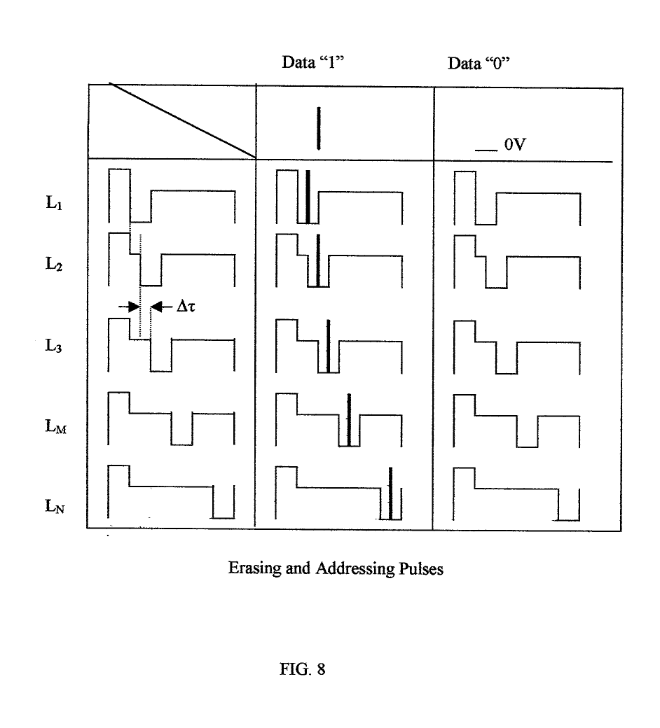

Turning now to the FIG. 8, illustrated is a partial addressed video speed driving scheme. What is different from FIG. 7 is that the driving scheme allows coexistence of information displaying and information erasing in the same frame. The row driver becomes waveform synthesizer which generates both the erasing pulse and part of the addressing pulse. The column driver only supplies Data “1” narrow pulse.

Compared with the waveform introduced in FIG. 7, the row driver has heavier power load because it have to take care of both erasing pulse and most part of addressing pulse At least one thing is certain that a conventional STN driver will be able to qualify as the waveform generator. Since STN driver can generate four-level voltages that totally satisfy with the requirement of the video rate row driver in the present invention. However, the frame logic control signal should be enabled to switch the polarity of the waveform from positive to negative every frame, so as to eliminate the DC charge in liquid crystal material.

The column driver, on the other hands, is no longer a contributor of the erasing pulse and specialized for the data input. The skilled of the art allows to utilize a TFT driver as well as the STN driver. TFT driver is famous for the pulse-height-modulation for a gray scale display mode. In a motion video display, the data signal, before getting into the TFT driver circuit, has been converted from R.G.B analog video signal to 8 gray scale digital signal by a LCD video interface controller (LVIC). By using the TFT driver, originally only for the active video display, the present invention realizes a passive cholesteric motion video display with multi gray scale level. Since the TFT driver can modulate the pulse-height of Data “1”, consequently it will induce a mixture of cholesteric focal conic texture and field-induce nematic texture in the same-pixel, a principle of the gray scale display. Therefore, one of the most important functions of the driving waveform is that it is the best driving method for the cholesteric video-rate-gray-scale display.

The other very important function of the driving scheme is partially driving: one portion of the display is under erasing and addressing and the other portion of it is displaying. The frame rate will be increased as the display time no longer being a part of the frame time.

The above-mentioned display mode (FIG. 1) and driving means (FIG. 2-8) have been disclosed, in details, a motion video cholesteric display which is the best candidate of a true multimedia e-book. For example, many children's e-books have now been adapted to a multimedia “interactive” environment. “Interacting” with a multimedia e-book may be as simple as clicking objects on the display's screen to see what they do. Clicking a character from the book might make it jump around the screen. Clicking a window might make it open and then slam shut. Clicking a cloud in the sky might make erupt from the speakers. To be a true multimedia e-book, of course, it must also contain sound as well as picture and animations, On the other hand, the multimedia e-book must be a “green” product, save energy and human friendly. Cholesteric display is obviously superior to the currently TFT AM LCD and STN LCD in such applications.

I claim:

1. A motion video display comprising:
a. a plurality of polarizers with predetermined polarity;
b. a plurality of transparent conductive patterning substrates juxtaposed to form a passive-matrix cell structure;
c. a cholesteric material having field-maintained bistability with a viewable homeotropic texture and a viewable focal-conic texture;
d. a power supply programmed with a video speed driving means;
wherein the passive-matrix cell structure encases the cholesteric material with its two outside surfaces laminating with polarizers respectively, and with its two inside surfaces binding to the power supply;
whereby an optical “ON” state will be displayed in the viewable homeotropic texture area of the cell structure and an optical “OFF” state will be displayed in the viewable focal-conic texture area of the cell structure;
whereby the optical “ON” state and the optical “OFF” state are interchangeable in the same area of the cell structure at a motion video speed.

2. The display as in claim 1 wherein the homeotropic “ON” state is an optical wave-guiding state which maintains the phase and polarity of the incoming light.

3. The display as in claim 1 wherein the focal-conic “OFF” state is an optical depolarizing state which changes the phase and polarity of the incoming light.

4. The display as in claim 1 wherein the field-maintained bistability means homeotropic metastable state and focal-conic stable state maintained by a voltage level during the motion video display.

5. The display as in claim 1 wherein the motion video cholesteric display is a high resolution display with a speed of at least 30 frames per second.

6. The display as in claim 1 further including a zero-field cholesteric planar texture as the other optical “ON” state which maintains the phase and polarity of the incoming light within the Bragg reflection band-width.

7. The display as in claim 6 wherein the display has dual working functions: motion video display where the homeotropic texture takes on optical “ON” state when the electric power is on, and motionless information display where the planar texture takes on the optical “ON” state when the electric power is off.

8. The display as in claim 6 wherein the homeotropic texture and the planar texture have substantially same optical appearances.

9. The display as in claim 1 wherein the motion video cholesteric display is a reflective display.

10. The display as in claim 1 wherein the motion video cholesteric display is a transmissive display.

11. A video speed driving waveform comprising:
a. an erasing pulse with its configuration sufficiently activating at least a portion of display's elements to the homeotropic texture;
b. a bias voltage with its configuration sufficiently maintaining the homeotropic texture and the focal-conic texture;
c. a “hole” pulse with its configuration sufficiently activating display's elements to focal-conic texture;
d. a narrow pulse combined with the “hole” pulse activating display's elements at least partially to homeotropic texture;
e. a waveform sequence: first, the frame erasing pulse; second, the bias pulse following the erasing pulse and lasting to the end of the frame except being interrupted by the “hole” pulse; third, the narrow pulse and the “hole” pulse constantly shifting from one row to another, during a frame addressing with an interval of the narrow pulse pulse-width; fourth, the waveform sequence may or may not being repeated immediately by the next frame;
whereby a video speed display driving scheme with at least 30 frames per second is accomplished.

12. The driving waveform as in claim 11 wherein the erasing pulse is a pulse with the amplitude, V_{E}, higher than the cholesteric to field-induced nematic phase change voltage and with the pulse-width in the range of 5-50 milliseconds for the first frame, and 1-5 milliseconds for the following frames.

13. The driving waveform as in claim 11 wherein the bias voltage is V_{B}, a maintaining voltage with the amplitude
0.1 V_{CN}≦V_{B}≦0.9 V_{NC},
and with the duration
T_{B}=T_{F}−T_{E}−Δτ.

14. The driving waveform as in claim 11 wherein the “hole” pulse is a negative pulse with the altitude, V_{B}, and pulse-width, τ_{NC}, in the range of 0.5-1 millisecond.

15. The driving waveform as in claim 11 wherein the narrow pulse is a data “1” pulse with the pulse-width, Δτ, in the range of 20-60 microseconds.

16. The driving waveform as in claim 11 wherein the waveform sequence may or may not being repeated immediately to the next frame means that if it is repeated immediately to the next frame, there will be a motion video display with frame time,
T_{F}=T_{FA}=T_{E}+τ_{NC}+nΔτ,
and that if it is separated by a display time, T_{FD}, there will still be a motion video display with frame time,
T_{F}=T_{FA}+T_{FD}=T_{E}+τ_{NC}+nΔτ+T_{FD},
and that if it is separated in a sufficient long period, there will be a motionless information display with display time,
T_{FD}>>T_{FA}.

17. The driving waveform as in claim 11 wherein the narrow pulse activating display's elements, at least partially, to homeotropic texture means that the data “1” pulse can be amplitude-modulated to achieve a gray-scale display.

18. The driving means as in claim 11 further including a partial driving scheme wherein the row driver generates the whole erasing pulse and major portion of the addressing pulse so that the erasing and addressing can be carried out from any portion of the display.

19. A display driver's signal logic comprising:
a. a plurality of data “1” positive single pulse signals;
b. a plurality of data “0” zero voltage signal;
c. a scanning negative single pulse signal;
d. a synchronized signal;
wherein the data “1” and data “0” signals out of the column driver and the scanning single pulse out of the row driver are synchronized and applied to the display's elements in such a way that the scanning pulse is shifting from the first line to the last line of the display area with the interval of data “1” pulse-width in a video frequency;
whereby a true binary data generates two-dimensionally optical “ON” and “OFF” states on the display's elements in a video speed.

20. The driver logic signal as in claim 19 wherein the column driver and row driver are TFT driver and STN driver respectively.
